(19) United States
(12) Patent Application Publication
(10) Pub. No.: US 2012/0049626 A1
(43) Pub. Date: Mar. 1, 2012

(54) POWER DEMAND SURGE MANAGEMENT CIRCUIT

(76) Inventors: Jian Xu, Windsor (CA); John Gerard Finch, Livonia, MI (US)

(21) Appl. No.: 12/871,956

(22) Filed: Aug. 31, 2010

(51) Int. Cl. H02J 3/00

(52) U.S. Cl. 307/41

(57) ABSTRACT

A method of turning on a plurality of loads connected to a multi-channel power controller includes turning ON a first load, comparing a current-related value of the first load to a predefined threshold, and turning ON a second load after a selected one of a first time delay or a second time delay in response to the comparison.

### BACKGROUND

This disclosure relates to power management, and more particularly to a power demand surge management circuit.

Certain loads have much higher start-up power demand surges than their stable ON power demand. When such loads are connected to multi-channel power sources (e.g. those available from NexTek), their start-up power demand surges may cause an overload protection circuit to trip and turn OFF the loads if multiple channels are switched ON simultaneously.

### SUMMARY

A method of turning on a plurality of loads connected to a multi-channel power controller includes turning ON a first load, comparing a current-related value of the first load to a predefined threshold, and turning ON a second load after a selected one of a first time delay or a second time delay in response to the comparison.

A power control circuit includes a multi-channel power supply operable to selectively connect a plurality of loads to one of its channel outputs and a surge management circuit. The surge management circuit is configured to stagger the turn ON times of the plurality of loads such that the controller turns ON a first load, and turns ON a second load after a first time delay in response to a first condition, and turns ON the second load after a second time delay in response to a second condition.

These and other features of the present invention can be best understood from the following specification and drawings, the following of which is a brief description.

### BRIEF DESCRIPTION OF THE DRAWINGS

FIG. 1 schematically illustrates a power control circuit.

FIG. 2a schematically illustrates a example method of turning ON a plurality of loads connected to a multi-channel power controller.

FIG. 2b schematically illustrates another example method of turning ON a plurality of loads connected to a multi-channel power controller.

### DETAILED DESCRIPTION

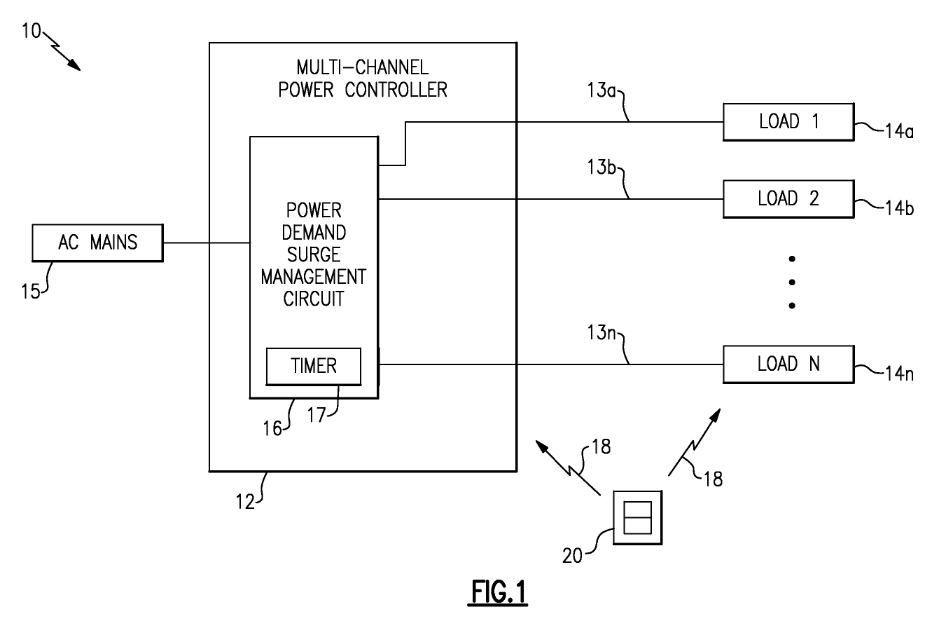

FIG. 1 schematically illustrates a power control circuit 10 that includes a multi-channel power controller 12 that acts as a power supply by receiving a power input (e.g. AC mains 15) and selectively connecting a plurality of loads 14a-n to one of its channel outputs 13a-n. A power demand surge management circuit 16 monitors a current-related value of the loads 14a-n, and staggers the turn ON times of the loads 14a-n such that if the current-related value of a first load (e.g. 14a) is less than a predefined threshold, then the circuit 16 turns ON a second load (e.g. 14b) after a first time delay Δt₁, and if the current-related value of the first load (e.g. 14a) is greater than the predefined threshold, then the circuit 16 turns ON the second load after a second time delay Δt₂ or a multiple of the time delay Δt₂.

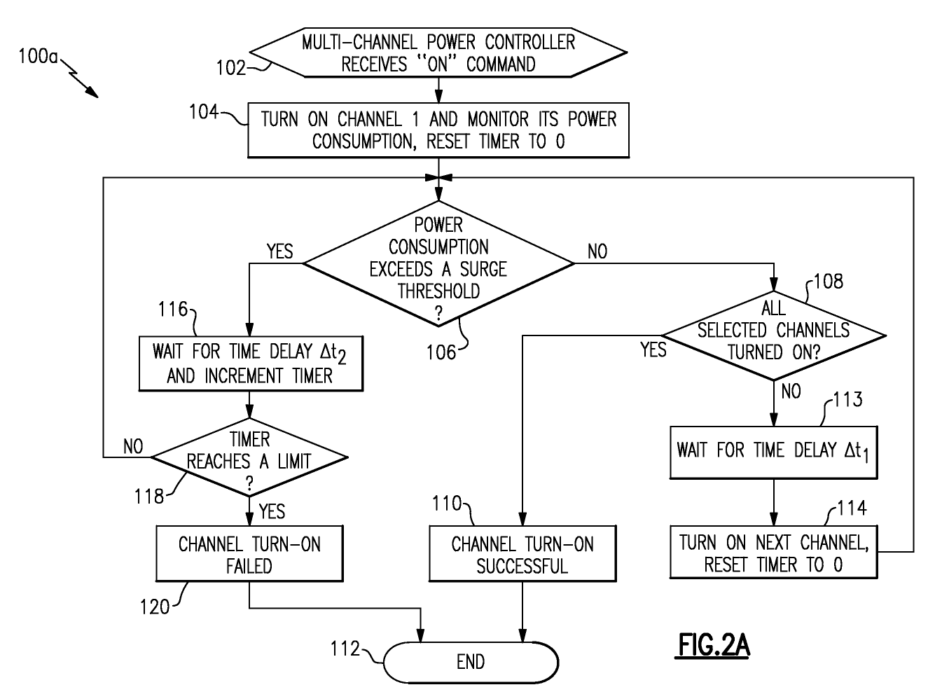

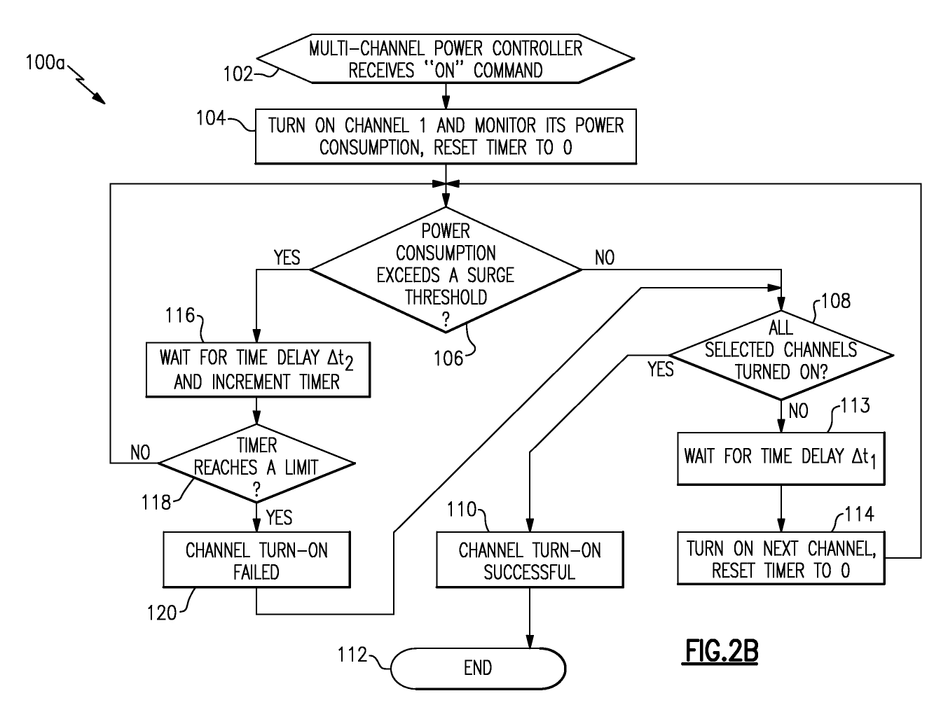

In one example the current-related value is a power consumption and the predefined threshold is a power threshold (as Power=Voltage*Current). For the sake of example, power consumption is illustrated in FIGS. 2a and 2b and will be discussed below. However, it is understood that power consumption is only an example, and that other current-related values and thresholds could be used. For example, the current-related value may be an energy consumption and the predefined threshold may be an energy threshold (as Energy=Voltage*Current*Time).

FIG. 2a schematically illustrates an example method 100a implementing the staggered turn ON times described above. The method 100 may be used to minimize the power surge associated with inrush currents of the loads 14a-n. The method 100a will be described in connection with a command to turn ON loads 14a-b. Once the turn ON command is received (step 102), the load 14a would be turned ON, the power consumption of the load 14a would be monitored, and a timer 17 would be reset (step 104).

A comparison of the power consumption of the load 14a to the power threshold would then be performed (step 106). If the power consumption of load 14a was less than the power threshold, a check is performed to determine if additional loads need to be turned ON pursuant to the command of step 102 (step 108). If all selected loads have been turned ON, a successful turn ON determination would be made (step 110) and the method would end (step 112). However, in this example two loads are commanded ON, so the circuit 16 would wait for a first time delay Δt₁ to elapse (step 113), and then the subsequent channel (which in this example is load 14b) would be turned ON and the timer would be reset to zero (step 114). Then steps 106, 108, and 110 could be performed to complete the method 100 as both loads 14a-b would be turned ON.

However, if step 106 resulted in a determination that the power consumption of load 14a did exceed the power threshold, then the surge management circuit 16 would wait for the second time delay Δt₂ to elapse, and would increment the timer 17 (step 116). A check would be performed to determine if the timer 17 has reached its limit (step 118). If the timer 17 was beneath its limit, steps 106, 116 and 118 could be repeated until either the timer limit was reached or until the power consumption of the load 14a no longer exceeded the power threshold. If the timer limit was reached, a load turn ON failure determination would be made (step 120) and the method would end (step 112). Alternatively, as shown in the method 100b of FIG. 2b, if the timer limit was reached, the surge management circuit 16 may simply advance to a subsequent channel for which a turn ON command has been received (see step 108 in FIG. 2b).

Thus, the duration of the second time delay can vary depending on how long it takes for the power consumption of a selected load 14a-n to fall beneath the power threshold, and the second time delay could be Δt₂ (e.g. step 116 performed once for a selected channel 13) or could be a multiple of Δt₂ (e.g. step 116 performed multiple times for a single channel 13). In one example the time delay Δt₁ is on the order of 1 microsecond, and the second time delay Δt₂ is on the order of 8 milliseconds. In one example, the first time delay corresponds to the inherent delay associated with an immediate command to turn ON the second load. Of course, these are only example delays, and other time delays could be used. Also, although the example of a command to turn on loads 14a-b has been described in connection with the method 100, it is understood that commands to turn on any selection of the plurality of loads 14a-n could be received and that the method 100 could be applied to those commands.

The power control circuit 10 is dynamic in that whether or not the second time delay Δt₂ is implemented is determined during operation and is not predetermined. For example, if turning on a first channel (e.g. 14a) does not exceed the power threshold, then a subsequent channel will be turned on after Δt₁ and not Δt₂. Also if only the first channel (e.g. 14a) and the fourth channel (e.g. 14n) are commanded ON, the fourth channel will not simply turn on after 4* Δt₁ or 4*Δt₂, the fourth channel could turn on after Δt₁ (if the power consumption of load 14a was beneath the power threshold) or could turn on after Δt₂ or a multiple of Δt₂ (depending on how long it takes for the power consumption of the load 14a to fall beneath the power threshold).

The circuit 10 may implement wireless switching functionality such that the circuit 10 is responsive to wireless signals 18 transmitted by one or more self-energizing switches 20. In one example the self-energizing switch 20 corresponds to a energy-harvesting switch by Enocean. In one example the power controller 12 is responsive to the wireless signals 18. In one example a portion of the loads 14a-b are also power controllers that in turn control downstream loads. In this example the downstream multi-channel power controllers (e.g. loads 14a-n) could be distributed throughout a structure, such as a home, and a flow of current to each of those downstream power controllers could be controlled using a single upstream multi-channel power controller 12. In one example each of the downstream multi-channel power controllers (e.g. loads 14a-n) are also responsive to the wireless signals 18 from the self-energizing switch 20 or other self-energizing switches.

Although a preferred embodiment has been disclosed, a worker of ordinary skill in this art would recognize that certain modifications would come within the scope of this disclosure. For that reason, the following claims should be studied to determine the true scope and content of this disclosure.

What is claimed is:

1. A method of turning on a plurality of loads connected to a multi-channel power controller, comprising the steps of:
(A) turning ON a first load;
(B) comparing a current-related value of the first load to a predefined threshold; and
(C) turning ON a second load after a selected one of a first time delay or a second time delay in response to the comparison.

2. The method of claim 1, wherein the current-related value is a power consumption and wherein the predefined threshold is a power threshold.

3. The method of claim 1, wherein the current-related value is an energy consumption and wherein the predefined threshold is an energy threshold.

4. The method of claim 1, wherein the first time delay is selected in response to the current-related value of step (A) not exceeding the predefined threshold and wherein the second time delay is selected in response to the current-related value of step (A) exceeding the predefined threshold.

5. The method of claim 1, wherein the first time delay corresponds to the inherent delay associated with a command to turn ON the second load.

6. The method of claim 1, wherein the second time delay is greater than the first time delay.

7. The method of claim 1, wherein steps (B)-(C) are selectively repeated to turn ON a plurality of additional loads.

8. The method of claim 7, wherein the first load, the second load, and each of the plurality of additional loads are connected to a single power input.

9. The method of claim 1, wherein if step (B) indicates a current-related value that exceeds the predefined threshold then step (C) includes the steps of:
(D) waiting for a time period to elapse;
(E) repeating said step (B); and
(F) selectively repeating steps (D)-(E) until either said step (B) indicates that the current-related value is below the predefined threshold or said step (B) has been performed a predefined maximum quantity of times for the first load.

10. The method of claim 9, including:
(G) turning ON the second load in response to said step (B) indicating that the current-related value is below the predefined threshold.

11. The method of claim 9, including:
(G) leaving the second load in an OFF state in response to step (B) being performed the predefined maximum quantity of times for the first load.

12. The method of claim 9, wherein the second time delay corresponds to the sum of the time periods from said step (D).

13. The method of claim 9, including the step of:
receiving a command to turn ON at least one of the first load and the second load as a wireless control signal from a self-energizing switch.

14. A power control circuit, comprising:
a multi-channel power supply operable to selectively connect a plurality of loads to one of its channel outputs; and
a surge management circuit configured to stagger the turn ON times of the plurality of loads such that the controller turns ON a first load, and either turns ON a second load after a first time delay in response to a first condition, or turns ON the second load after a second time delay in response to a second condition.

15. The circuit of claim 14, wherein one of the plurality of loads includes a plurality of individual loads connected to a single channel output.

16. The circuit of claim 14, wherein the surge management circuit also staggers the turn ON times of the plurality of loads beyond the first and second load.

17. The circuit of claim 14, wherein the first condition corresponds to a current-related value of the first load being below a predefined threshold, and wherein the second condition corresponds to the current-related value of the first load exceeding the predefined threshold.

18. The circuit of claim 17, wherein the current-related value is a power consumption and wherein the predefined threshold is a power threshold.

19. The circuit of claim 17, wherein the current-related value is an energy consumption and wherein the predefined threshold is an energy threshold.

20. The circuit of claim 16, wherein the first time delay corresponds to the inherent delay associated with a command to turn ON the second load.

21. The circuit of claim 16, wherein the second time delay is greater than the first time delay.

22. The circuit of claim 16, wherein if the second time delay corresponds to at least one time period of a timer, wherein the at least one time period is selectively repeated until either the current-related value of the first load is less than the predefined threshold or the at least one time period has been repeated a predefined maximum quantity of times for the first load.

23. The circuit of claim 13, wherein at least one of the plurality of loads is also a multi-channel controller operable to selectively connect a plurality of downstream loads to the power source.

24. The circuit of claim 13, wherein the controller is responsive to wireless control signals from a self-energizing switch.
